(19) United States
(12) Patent Application Publication
(10) Pub. No.: US 2011/0194614 A1
(43) Pub. Date: Aug. 11, 2011

(54) De-Blocking Filtering Control

(76) Inventors: Andrey Norkin, Solna (SE); Kenneth Andersson, Gavle (SE); Clinton Priddle, Indooroopilly (AU)

(21) Appl. No.: 13/021,012

(22) Filed: Feb. 4, 2011

Related U.S. Application Data
(60) Provisional application No. 61/301,732, filed on Feb. 5, 2010.
(60) Provisional application No. 61/305,005, filed on Feb. 16, 2010.

(30) Foreign Application Priority Data
Dec. 29, 2010 (SE) PCT/SE2010/051494

(51) Int. Cl. H04N 7/26; G06K 9/40

(52) U.S. Cl. 375/240.24; 382/260; 375/240.25; 375/E07.193; 375/E07.027

(57) ABSTRACT

First and second filter decision values are calculated for a pixel block in a video frame. The first filter decision value is representative of how smooth pixel values in a first line of pixels in the block and in a corresponding first line of pixels in a neighboring pixel block in the video frame are in a direction parallel to a filtering direction. The second filter decision value is representative of how close pixel values in a current line of pixels in the block approximate a flat line and how close pixel values in a corresponding current line of pixels in the neighboring block approximate a flat line. The two filter decision values are compared to respective thresholds and a strong de-blocking filter is selected for the current line if the filter decision values are below the thresholds, otherwise a weak de-blocking filter is selected to combat any blocking artifacts.

### RELATED APPLICATIONS

This application claims priority to U.S. Provisional Patent Application No. 61/301,732, filed Feb. 5, 2010, U.S. Provisional Patent Application No. 61/305,005, filed Feb. 16, 2010, and International Patent Application No. PCT/SE2010/051494, filed Dec. 29, 2010, each of which is incorporated herein by reference in its entirety.

### TECHNICAL FIELD

The present invention generally relates to filtering control and in particular to controlling de-blocking filtering over block boundaries in a video frame.

### BACKGROUND

Encoding of video frames may introduce blocking artifacts to the encoded data. Such blocking artifacts are mainly due to discrete cosine transforms in intra and inter frame prediction error coding. Discontinuities at boundaries between blocks can then become visible to a viewer during reconstruction. Another common source of blocking artifacts is motion compensated prediction.

The traditional approach of combating such blocking artifacts is to use de-blocking filtering. In state of the art video coding, such as H.264, loop filtering with an adaptive de-blocking filter is performed after prediction and residual coding, but before storage of the reconstructed frame for later reference when encoding the following frames, see List et al., Adaptive Deblocking Filter, IEEE Transactions on Circuits and Systems for Video Technology, 2003, 13(7): 614-619. The loop filtering consists of filter decision, filtering operation, clipping function and change of pixel value. The decision to filter the border or not is made based on evaluating several conditions. The filter decision depends on macroblock type, motion vector (MV) difference between neighboring blocks, if one of the neighboring blocks has a coded residual and on the local structure of a current block or the neighboring blocks.

Then the amount of filtering depends on the position of the pixel compared to the block boundary and on the quantization parameter used for residual coding for the current block.

In H.264, a filter decision is made based on pixel values between the block boundary of two neighboring blocks. This applies both to the vertical block boundary and horizontal block boundary. The boundary can be illustrated by pixels a, b, c and d in one block and e, f, g and h in another block where the block boundary is between d and e, see below:

abcd|efgh

The filter decision is based on comparing three pixel differences with three thresholds. The thresholds are adapted to the quantization parameter (QP). If the following conditions are fulfilled the filter decision is positive |d−e|<T₁, |c−d|<T₂, and |e−f|<T₂, where T₁ and T₂ are adapted based on QP.

There are two filtering modes in H.264. In the first filtering mode (normal filtering), filtering can be described with a delta value (Δ) that the filtering changes the current value. The filtering for the pixel closest to the block boundary is:

d′=d+Δ_{c} and e′=e−Δ_{c}

where Δ_{c} has been clipped off to a threshold±T₃ to a value that is constrained by the QP. More filtering is allowed for high QP than for low QP. Clipping can be described as:

Δ_{c}=Max(−T₃, Min(T₃, Δ))

The filter strength can be increased if any of the following two conditions also holds |b−d|<T₂ and |e−g|<T₂. The filter strength is also adapted by clipping the delta value less, e.g. to allow for more variation.

The second (strong) filtering mode is only applied for an intra macroblock boundary, when the following condition is fulfilled |d−e|<T₁/4.

A significant limitation with the adaptive de-blocking filter employed in H.264 is that second, strong filtering mode can only be applied over macroblock edges if at least one of the blocks is an intra block. However, also small differences in nearly uniform image areas can also occur for other blocks than intra coded blocks and also within internal macroblocks. It would then be desired to be able to apply strong filtering also to such cases. However, it is then important that the filtering control is able to distinguish between true edges in the image and those that due to blocking artifacts.

US 2006/0078048 discloses a simplification applicable to de-blocking filtering in H.264 that reduces the computational complexity as compared to standard filtering decisions of H.264. The decision test for conducting normal filtering or no filtering is performed on one line or a subset of the lines crossing the boundary between two macroblocks. This decision then applies to all lines crossing the same boundary. As a consequence, a single filtering decision is calculated per macroblock boundary and this single filtering decision applies to all lines crossing the macroblock boundary.

A significant limitation with the adaptive de-blocking filtering disclosed in US 2006/0078048 is that only normal filtering can be conducted, which can lead to visible artifacts over block boundaries since stronger filtering is not possible.

### SUMMARY

It is a general objective to provide an efficient de-blocking filtering to combat or reduce blocking artifacts.

This and other objectives are met by embodiments as disclosed herein.

An aspect of the embodiments defines a filtering control method applicable to a block of multiple pixels in a video frame. The method involves calculating a first filter decision value for the block. The first filter decision value is representative of how smooth pixel values in a first line of pixels in the block and in a corresponding first line of pixels in a neighboring block of multiple pixels in the video frame are in a direction parallel to the filtering direction over the block boundary between the block and the neighboring block. A second filter decision value is also calculated for the block and is representative of how close pixel values in a current line of pixels in the block approximate a flat line and how close pixel values in a corresponding current line of pixels in the neighboring block approximate a flat line. The first filter decision value is then compared to a first threshold and the second filter decision value is correspondingly compared to a second threshold. If both filter decision values are below its respective threshold a strong de-blocking filter is selected for the current line of pixels to filter at least one of the pixel values in the current line. However, if not both filter decision values are below the respective thresholds, a weak de-blocking filter is instead selected for the current line of pixels. The weak de-blocking filter has a comparatively lower filtering strength as compared to the strong de-blocking filter.

Another aspect of the embodiments relates to a filtering control device comprising a first decision value calculator configured to calculate a first filter decision value for a block of multiple pixels in a video frame. The first filter decision value is, as mentioned in the aspect above, representative of how smooth pixel values in a first line of pixels in block and in a corresponding first line of pixels in the neighboring block of pixels in the video frame are in a direction parallel to the filtering direction. A second decision value calculator is implemented to calculate a second filter decision value for the block representative of how close pixel values in a current line of pixels in the block approximate a flat line and how close pixel values in a corresponding current line of pixels in the neighboring block approximate a flat line. The filtering control device also comprises a first threshold comparator and a second threshold comparator configured to compare the first and the second filter decision value to a first and a second threshold, respectively. A filter selector is connected to the first threshold comparator and second threshold comparator and is configured to select a strong de-blocking filter to filter at least one pixel value in the current line of pixels if the first filter decision value is below the first threshold and if the second filter decision value is below the second threshold. If both these conditions are not met the filter selector instead selects a weak de-blocking filter having a comparatively lower filtering strength as compared to the strong de-blocking filter.

Further aspects of the embodiments relates to an encoder and a decoder comprising a filtering control device and a media terminal comprising a decoder.

The aspects of the embodiments enable selection between strong and weak de-blocking filtering to combat blocking artifacts present at the boundary between two blocks of pixels in a video frame. According to the embodiments a strong de-blocking filter can be selected irrespective of the encoding mode, such as intra versus inter coding, of the blocks of pixels but rather based on the particular pixel values in the blocks and in respective lines of the blocks. This leads to a more efficient and better de-blocking filtering.

### BRIEF DESCRIPTION OF THE DRAWINGS

The invention, together with further objects and advantages thereof, may best be understood by making reference to the following description taken together with the accompanying drawings, in which:

FIG. 1 is a flow diagram illustrating a filtering control method according to an embodiment;

FIGS. 2A and 2B illustrate two embodiments of neighboring blocks and a block boundary over which de-blocking filtering can be applied;

FIG. 3 is a flow diagram illustrating additional steps of the method in FIG. 1 according to an embodiment;

FIGS. 4A to 4C illustrate the effects of three different filtering decisions according to various embodiments;

FIG. 5 is a flow diagram illustrating an additional step of the method in FIG. 3 according to an embodiment;

FIG. 6 is a flow diagram illustrating an additional step of the method in FIG. 1 according to an embodiment;

FIG. 7 is a drawing schematically illustrating block-wise and line-wise filtering decisions according to an embodiment;

FIG. 8 is a flow diagram illustrating additional steps of the method of FIG. 1 according to an embodiment;

FIG. 9 is a flow diagram illustrating an additional step of the method of FIG. 8 according to an embodiment;

FIG. 10 is a flow diagram illustrating an additional step of the method of FIG. 1 according to an embodiment;

FIG. 11 is a schematic block diagram of an embodiment of a filtering control device;

FIG. 12 is a schematic block diagram of another embodiment of a filtering control device;

FIG. 13 is a schematic block diagram of a further embodiment of a filtering control device;

FIG. 14 illustrates an implementation of a filtering control device according to an embodiment;

FIG. 15 is an implementation of a filtering device according to another embodiment;

FIG. 16 is a schematic block diagram of an encoder according to an embodiment;

FIG. 17 is a schematic block diagram of a decoder according to an embodiment; and

FIG. 18 is a schematic block diagram of a media terminal according to an embodiment.

### DETAILED DESCRIPTION

Throughout the drawings, the same reference numbers are used for similar or corresponding elements.

The embodiments generally relate to adaptive de-blocking filtering or adaptive loop filtering, as it is sometimes denoted, to combat blocking artifacts over block boundaries in a video frame. The embodiments introduce specific filter decisions that are employed to determine whether to apply strong filtering or weak filtering to respective pixel lines in the block. The particular filter decisions together with the possibility of using strong or weak filtering enables efficient reduction of blocking artifacts but without an increase in computation complexity.

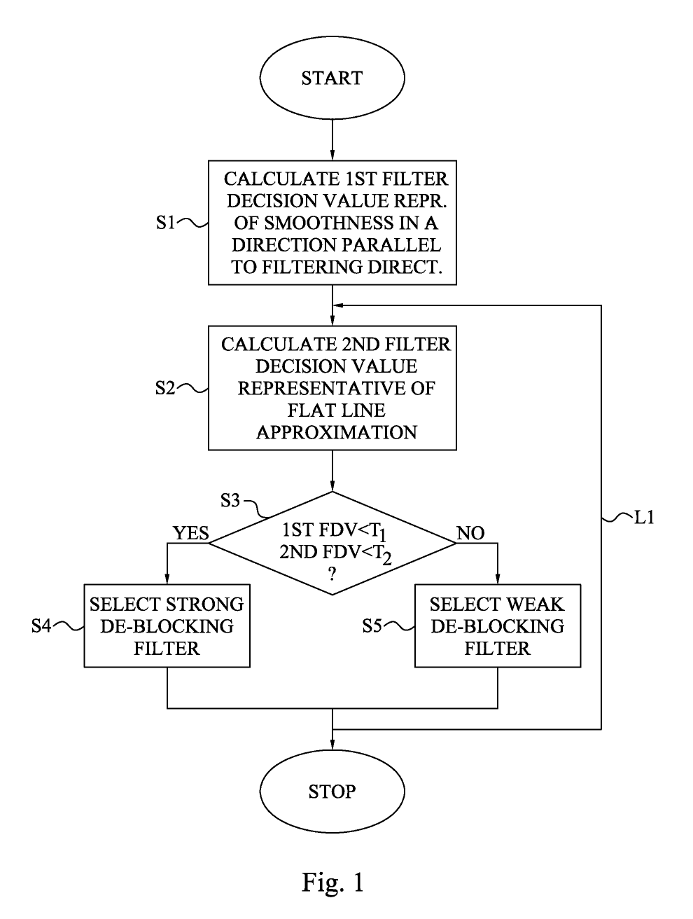

FIG. 1 is a flow diagram of a filtering control method according to en embodiment applicable to a block of multiple pixels in a video frame. As is well-known in the art, a video frame is divided into non-overlapping blocks of pixels that are encoded and decoded according to the various available intra and inter coding modes. Generally, a video frame is divided into non-overlapping macroblocks of 16×16 pixels. Such a macroblock can in turn be divided into smaller blocks of different sizes, such as 4×4 or 8×8 pixels. However, also rectangular blocks could be possible according to the embodiments, such as, 4×8, 8×4, 8×16 or 16×8. The embodiments can be applied to any such block of pixels, including macroblocks or even larger blocks of pixels. In a particular embodiment, the filtering control method is applicable to all blocks of multiple pixels having at least 8 pixels in the vertical direction and/or horizontal direction. In the art, prediction unit partition and transform unit are commonly employed to denote such a block of multiple pixels.

In the emerging High Efficiency Video Coding (HEVC) standard, coding units (CU) are used. The CU size is currently varying from 64×64 pixels (largest) to 4×4 pixels (smallest). In this way, the largest CU can be split into smaller CUs with the “level of granularity” depending on the local characteristics of the frame. That means that the largest CU may be split into smaller CUs of different sizes. The embodiments can also be used in connection with such coding units, which are regarded as being encompassed by the expression “block of pixels” as used herein.

Each pixel in the block has a respective pixel value. Video frames generally have color values assigned to the pixels, where the color values are represented in a defined color formats. One of the common color formats uses one luminance component and two chrominance components for each pixel, although other formats exist, such as using red, green and blue components for each pixel.

Traditionally, luminance component filtering and chrominance component filtering are done separately possibly employing different filtering decisions and different de-blocking filters. The embodiments can be applied to filter the luminance component, filter the chrominance component or filter both the luminance component and the chrominance component. In a particular embodiment, the embodiments are applied to achieve luminance or luma filtering.

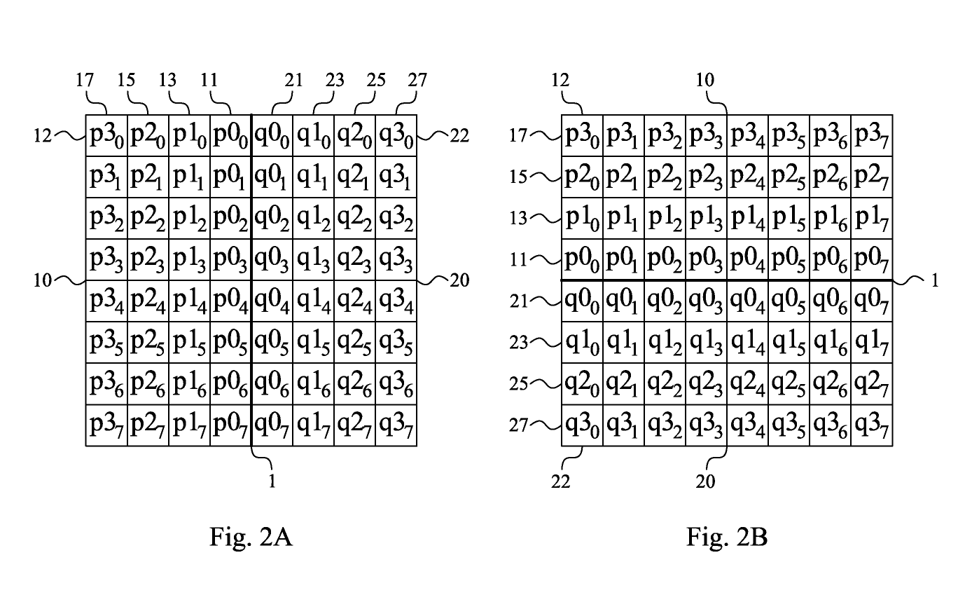

Adaptive de-blocking filtering is conducted over a boundary, edge or border between neighboring blocks. As a consequence, such boundaries can be vertical boundaries 1, see FIG. 2A, between two neighboring blocks 10, 20 present side by side in the video frame. Alternatively, the boundaries are horizontal boundaries 1, see FIG. 2B, between two neighboring block 10, 20, where one block 10 is positioned above the other block 20 in the video frame. In a particular embodiment, vertical boundaries are filtered first starting from the left-most boundary and proceeding through the boundaries towards the right-hand side in their geometrical order. Then, horizontal boundaries are filtered starting with the boundary on the top and proceeding through the boundaries towards the bottom in their geometrical order. The embodiments are, however, not limited to this particular filtering order and can actually be applied to any predefined filtering order. In a particular embodiment, the boundaries at the edge of the video frame are preferably not filtered and thereby excluded from the de-blocking filtering.

The method of this embodiment starts in step S1 where a first filter decision value is calculated for the block. This calculated filter decision value is representative of how smooth pixel values in a first line of pixels in the block and in a corresponding first line of pixels in a neighboring block in the video frame are in a direction parallel to the filtering direction. The first line of pixels in the current block and the corresponding line of pixels in the neighboring block belong to the same horizontal line extending over a vertical boundary or belong to the same vertical line extending over a horizontal boundary.

The first line of pixels in the block is preferably a predefined horizontal or vertical line of pixels. The first line thereby corresponds to a predefined pixel row or pixel column in the blocks of the video frame. For instance, the first line could correspond to row number j or column number j in the block. This then means that the first line of another block to be subsequently filtered would correspond to row number j or column number j in that another block.

The first filter decision thereby investigates the smoothness of the pixel values in a direction parallel to the filtering decision. In other words, the first filter decision investigates whether the pixel values in the first line in a block and the pixel values in a corresponding first line of a neighboring block are smooth, i.e. vary little or at least no more than a defined maximum amount, from a direction parallel to the filtering direction over the block boundary. Such smooth pixel values will give a zero or a low first filter decision value and should, though depending on the result from a second filter decision, generally be strongly filtered since the pixel values are smooth with no or very little structures.

A particular case of smooth pixel values in a direction parallel to the filtering direction could be if the pixel values of the first line approximate a plane and if the pixel values of the corresponding first line approximate a plane. The first filter decision could then be regarded as a detector for any planes on both sides of the boundary. The first filter decision value will therefore be equal to zero or at least close to zero when pixel values on both sides of the boundary form approximate planes. However, in some embodiments, horizontal/vertical lines crossing a vertical/horizontal boundary should be filtered although they do not form a plane but are smooth in the direction parallel to the direction of filtering.

A next step S2 calculates a second filter decision for the block. The second filter decision value is representative of how close pixel values in a current line of pixels in the block approximate a flat line and how close pixel values in a corresponding current line of pixels in the neighboring block approximate a flat line.

The current line of pixels is not, in contrast to the first line for the first filter decision, a fixed line in the block. Hence, a second filter decision value is preferably calculated for each line in the block so that each horizontal or vertical line will then preferably have a respective calculated second filter decision value, whereas a single filter decision value is calculated per vertical or horizontal boundary of the block.

In clear contrast to the first filter decision that investigates the smoothness of pixel values in a direction parallel to the filtering direction and which therefore can produce a zero first filter decision value also for pixel values forming a ramp (see left part of FIG. 4B), the second filter decision investigates the flatness of pixel values. Pixel values in the current line and in the corresponding current line are regarded to approximate a flat line if the investigated pixel values of the block and the investigated pixel values of the neighboring block are equal or almost equal. In such a case, the second filter decision value will be zero or close to zero. If the pixel values approximate a flat line this means that the pixels in the current line and in the corresponding current line do not have any significant structures and strong filtering could be preferred to smooth any blocking artifacts.

A next step S3 compares the first filter decision value (FDV) with a first threshold (T₁) and compares the second filter decision value with a second threshold (T₂). If the first filter decision value is below the first threshold and the second filter decision value is below the second threshold, the method continues to step S4, where a second or strong de-blocking filter is selected to be applied to pixels in the current line of pixels to filter and change the value of at least one pixel value in the current line. However, if any of the first and second filter decisions is not below its associated threshold in step S3, the method instead continues to step S5, where a first, normal or weak de-blocking filter is instead selected. The weak de-blocking filter is then applicable to pixels in the current line of pixels to filter and change the value of the at least one pixel value in the current line. The strong de-blocking filter selected in step S4 has then a comparatively higher filtering strength as compared to the weak de-blocking filter selected in step S5.

Once the filter decision has been taken for a current line in the block with regard to the current block boundary, the method returns to step S2 to calculate a new second filter decision value for another line of pixels in the block, which is schematically illustrated by the line L1. Thus, the loop formed by steps S2-S5 is preferably performed once for all pixel rows in a block for a vertical boundary and once for all pixel columns in a block for a horizontal boundary. The different pixel rows or pixel columns can be processed sequentially starting, for instance, with the upper row or the left-most column and then proceeding towards the bottom row or the right-most column in the block. Alternatively, the different pixel lines in the block can be processed in parallel to speed up the filtering control method.

Thus, step S1 is preferably only performed once for the current boundary in the block, which means that for most blocks step S1 will be conducted twice: once for its vertical boundary to a neighboring block and once for its horizontal boundary to a neighboring block.

Various embodiments of the first and second filter decisions will now be described in more detail.

The second filter decision is, as was mentioned above, indicative of how close pixel values in a current line of pixels approximate a flat line and how close pixel values in a corresponding current line of pixels in the neighboring block approximate a flat line. In a particular embodiment, the second filter decision considers the pixel values in the ends of the line in the block and in the ends of the corresponding current line in the neighboring block. With reference to FIGS. 2A and 2B, reference number 12 denotes a current line of pixels 11, 13, 15, 17 in the block 10 and the corresponding current line 22 of pixels 21, 23, 25, 27 in the neighboring block 20 extends along the same row (FIG. 2A) or the same column (FIG. 2B) as the current line 12 but on the other side of the boundary 1.

In this embodiment the second filter decision value is thereby calculated as |p3ᵢ−p0ᵢ|+|q0ᵢ−q3ᵢ|. In this formula and further herein pkᵢ denotes the pixel value of a pixel at row number i and column number k in the block 10, see FIG. 2A, or the pixel value of a pixel at column number i and row number k in the block 10, see FIG. 2B. qkᵢ correspondingly denotes the pixel value of a pixel in the neighboring block 20. In the particular block embodiment illustrated in FIGS. 2A and 2B k=0, 1, 2, 3, i=0, 1, 2, 3, 4, 5, 6, 7.

This means that the second filter decision is equal to the sum of the absolute difference between the pixel value of the pixel closest to, in the current line 12, the block boundary 1 and the pixel value of the pixel 17 third closest to (i furthest from in FIGS. 2A and 2B), in the current line 12, the block boundary 1 and the absolute difference between the pixel value of the pixel 17 in the neighboring block 20 closest to, in the corresponding current line 22, the block boundary 1 and the pixel value of the pixel 27 in the neighboring block 20 third closest to (i furthest from in FIGS. 2A and 2B), in the corresponding current line 22, the block boundary 1.

In an alternative embodiment, the second filter decision is calculated as |p3ᵢ−2p2ᵢ−p1ᵢ+2p0ᵢ|+|q0ᵢ−2q1ᵢ−q2ᵢ+2q3ᵢ|. The second filter decision is thereby, for a block of 4×8 or 8×4 pixels, based on calculating the absolute value of two times the pixel value of the pixel 11 closest to, in the current line 12, the block boundary plus the pixel value of the pixel 17 third closest to, in the current line 12, the block boundary 1 subtracted by the pixel value of the pixel 13 next closest to, in the current line 12, the block boundary 1 and subtracted by two times the pixel value of the pixel 15 second next closest to, in the current line 12, the block boundary 1. Also the absolute value is calculated of the pixel value of the pixel 21 in the neighboring block 20 closest to, in the corresponding current line 22, the block boundary 1 plus two times the pixel value of the pixel 27 in the neighboring block 20 third next closest to, in the corresponding current line 22, the block boundary 1 subtracted by two times the pixel value of the pixel 23 in the neighboring block 20 next closest to, in the corresponding current line 22, the block boundary 1 and subtracted by the pixel value of the pixel 25 in the neighboring block 20 second next closest to, in the corresponding current line 22, the block boundary 1. The sum of the two absolute values then constitutes the second filter decision value.

The benefit of this filter decision is that it does not give zero as output for a block boundary in the form of a ramp. It is further sensitive for edges and it attenuates the output for a linear increase of pixel values towards the block boundary.

The first filter decision value is representative of how smooth pixel values in the first line and in the corresponding first line are in a direction parallel to the filtering direction. In a particular embodiment, the first filter decision value is preferably based on |p2ⱼ−2p1ⱼ+p0ⱼ|+|q2ⱼ−2q1ⱼ+q0ⱼ, where j denotes the row number (FIG. 2A) or the column number (FIG. 2B) of the first line in the block 10 and the corresponding first line in the neighboring block 10. The first filter decision is thereby based on calculating the absolute value of the pixel value of the pixel closest to, in the first line, the block boundary 1 plus the pixel value of the pixel second next closest to, in said first line, the block boundary 1 subtracted by two times the pixel value of the pixel next closest to, in said first line, the block boundary 1. Also the absolute value of the pixel value of the pixel in the neighboring block 20 closest to, in the corresponding first line, the block boundary 1 plus the pixel value of the pixel in the neighboring block 20 second next closest to, in the corresponding first line, the block boundary 1 subtracted by two times the pixel value of the pixel of the neighboring block 20 next closest to, in the corresponding first line, the block boundary 1.

This filter decision embodiment checks whether the structures on both sides of the boundary are smooth in the direction parallel to the filtering direction.

In a particular embodiment the first filter decision value is calculated based on pixel values in the first line in the block and the first corresponding line in the neighboring block and in a second line in the block and a corresponding second line in the neighboring block. The first and second lines preferably correspond to predefined row numbers in the block (FIG. 2A) or predefined column numbers (FIG. 2B) and the corresponding first and second lines are the corresponding predefined row numbers or column numbers in the neighboring block.

The two lines are preferably distributed in the block. The first filter decision value could therefore be calculated as |p2₂−2p1₂+p0₂|+|q2₂−2q1₂+q0₂|+|p2₅−2p1₅+p0₅|+|q2₅−2q1₅+q0₅|. This means that an absolute value is calculated for row/column number two and row/column number five in the block 10 and for row/column number two and row/column number five in the neighboring block 20. Each absolute value is defined as the absolute value of the pixel value of said pixel closest to, in the relevant row/column, the block boundary 1 plus the pixel value of the pixel second next closest to, in the relevant row/column, the block boundary 1 subtracted by twice the pixel value of the pixel next closest to, in the relevant row/column, the block boundary 1.

Alternative embodiments for calculating the first filter decision value include |p2₂−2p1₃+p0₄|+|q2₂−2q1₃+q0₄|+|p2₅−2p1₄+p0₃|+|q2₅−2q1₄+q0₃ or |p2₂−2p1₃+p0₄+p2₅−2p1₄+p0₃|+|q2₂−2q1₃+q0₄+q2₅−2q1₄+q0₃|. In these two embodiments, lines in the block 10 and the corresponding lines in the neighboring block 20 are diagonal lines of multiple pixels.

A further alternative is to calculate the first filter decision value based on pixel values not in two lines and corresponding lines as described above but rather based on pixel values in four lines in the block and four corresponding lines in the neighboring block:

$${\sum }_{i = 2}^{5} ( \vert p {2}_{i} - 2 p {1}_{i} + p {0}_{i} \vert + \vert q {0}_{i} - 2 q {1}_{i} + {q2}_{i} \vert ) .$$

Variants of this embodiment include using row/column number zero, three, four and seven, row/column number one, two, five and six, row/column number zero, three, five and six or row/column number one, two, four and seven. These embodiments can also be applied to only using two lines and two corresponding lines, such as row/column number two and five.

In the above presented embodiments, two different filter decisions are employed to determine whether to apply strong filtering or weak filtering for a current line of pixels in the block. In some applications it could be preferred to additionally use a third filter decision. The reason for this is that any changes to pixel values caused by strong filtering (step S4 in FIG. 1) are not bound. For instance, if at least the pixel values in the first line and in the current line of the block and the pixel values in the corresponding first line and in the corresponding current line of the neighboring block are fairly equal the first and second filter decision values will both be equal to or close to zero. However, it could be possible that the pixel values in the first line and in the current line, though being fairly equal, differs quite much from the pixel values in the corresponding first line and in the corresponding current line. Such a situation could occur if there is a true structure or edge aligned with the block boundary. This means that the edge is not due to any blocking artifact but is an inherent property of the particular video frame and should therefore not be filtered away. It could therefore be advantageously to add a third filter decision in order to detect such edges aligned with the block boundary.

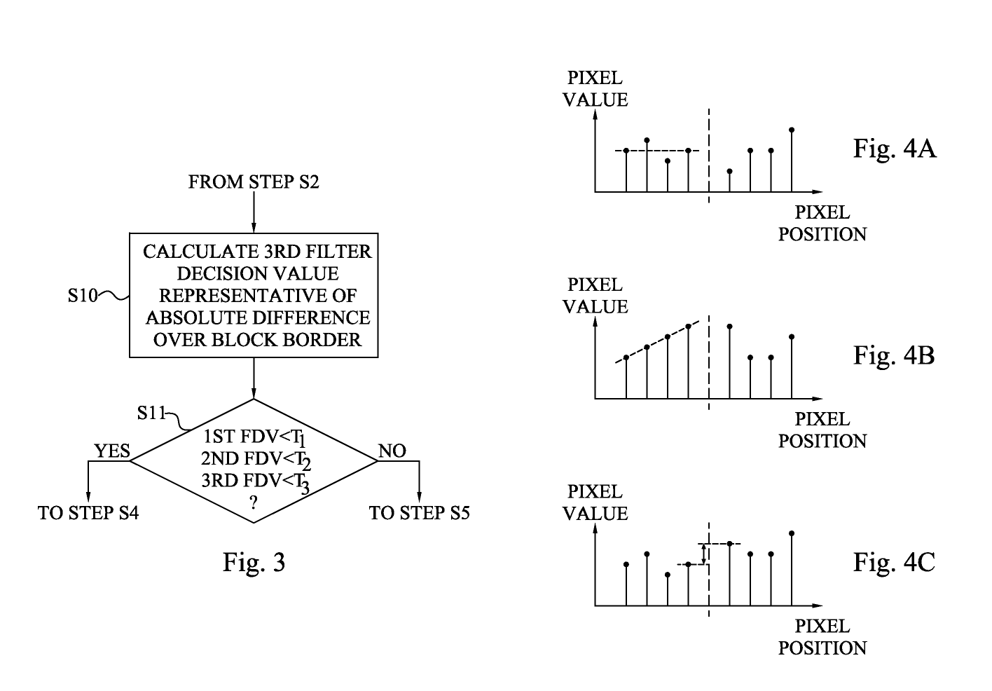

FIG. 3 is a flow diagram illustrating usage of a third filter decision value that will bind any pixel value changes caused by strong filtering and detect edges aligned with the block boundary. The method continues from step S2 in FIG. 1. A next step S10 calculates a third filter decision value for the block. The third filter decision value is representative of an absolute difference between the pixel value of the pixel closest to, in the current line, the block boundary and the pixel value of the pixel in the neighboring block closest to, in the corresponding current line, the block boundary. In other words, the third filter decision value is preferably equal to |p0ᵢ−q0ᵢ|. A next step S11 then compares the first filter decision value from step S1 in FIG. 1 with the first threshold, the second filter decision value from step S2 in FIG. 1 with the second threshold and the third filter decision value from step S10 with a third threshold (T₃). If all of the filter decision values are below their respective associated threshold the method continues to step S4 of FIG. 1, where a strong de-blocking filter is selected to be applied to pixels in the current line. Otherwise the method continues from step S11 to step S5 of FIG. 1, which instead selects a weak de-blocking filter.

Thus, in this embodiment the first filter decision value is calculated, for a given block boundary, once for the current block, whereas the second and third filter decision values are preferably calculated for each line orthogonal to the block boundary.

FIGS. 4A to 4C visually illustrate the effects of the three different filter decisions. In the diagrams the pixel values for the pixels in a line in the block and in the corresponding line in the neighboring block are illustrated. The block boundary is marked as a dashed vertical line in the figures. FIG. 4A corresponds to the second filter decision and investigates how close the pixel values in the current line and in the corresponding neighboring flat approximates a flat line. It is seen from the figure that the pixel values in the current line in the block can accurately be approximated with a flat line and will therefore give a value close to zero since the pixel values for the end pixels in the current line are equal in this example. However, the pixel values in the corresponding current line in the neighboring block cannot be approximated as a flat line. These pixels will therefore make a non-zero contribution to the first filter decision value.

FIG. 4B illustrates the pixel values along the first line and the corresponding first line in the block and the neighboring block. The pixel values of the pixel in the first line will be smooth in the direction parallel to the filtering direction. These pixel values in fact form a ramp and will make a zero contribution to a first filter decision value based on |p2ⱼ−2p1ⱼ+p0ⱼ|+|q2ⱼ−2q1ⱼ+q0ⱼ|. The pixel values in corresponding first line in the neighboring block will, however, make a non-zero contribution to the first filter decision value as they are not smooth in a direction parallel to the filtering direction.

Finally FIG. 4C illustrates the concept with the third filter decision value that is based on the absolute difference between the pixel values of the pixels closest to and on either side of the block boundary. If these values are equal or almost equal, the third filter decision value will be zero or small, whereas large differences will give rise to large third filter decision values and thereby prevent selection of strong de-blocking filtering for the current line.

FIG. 5 is a flow diagram illustrating an additional step of the filtering control method. This flow diagram illustrates an embodiment of determining the third threshold to be compared to the third filter decision value. The method continues from step S2 of FIG. 1. A next step S20 determines the third threshold value based on a quantization parameter selected for the block. The quantization parameter is selected for residual coding of the block and controls the quality of video compression, which is well known in the art and therefore not further described herein.

The determination of the third threshold based on the quantization parameter in step S20 preferably comprises determining the third threshold as T₃=a₁×t_{c}. The parameter t_{c} represents a clipping threshold selected for the block based on the quantization parameter. The parameter a₁ is a multiplier selected to prevent selecting the strong de-blocking filter if strong filtering with the strong de-blocking filter modifies the pixel value of the pixel closest to, in the current line, the block boundary with a value that is larger than a value which weak filtering with the weak de-blocking filter and the clipping threshold will modify the pixel value. Experimental tests have been conducted and verify that a₁=2.5 performs well. Additionally, a value of 2.5 implies that the third threshold can be calculated without any divisions as T₃=(t_{c}×5+1)>>1, where X>>Y denotes right shift of X by 2^{Y}, i.e. X/2^{Y}.

In an alternative embodiment, the parameter a₁ is determined based on the weak de-blocking filter selected in step S5 in FIG. 1. For instance, in the case of two flat blocks with the offset f₁ between the block and the neighboring block, the weak de-blocking filter according to H.264 (1-4 4-1)/8 interpolates the pixel values of the pixels closest to the block boundary with the value

$$p {0}_{i}^{′} = p {0}_{i} + \frac{3}{8} {f}_{1} and q {0}_{i}^{′} = q {0}_{i} - \frac{3}{8} {f}_{1} .$$

In such a case, the parameter a₁ could be selected as 8/3 as in such a case strong filtering will not be selected for flat blocks if it will produce stronger artifacts than the parameter t_{c} used to constrain weak filtering.

The above described embodiments of determining the third threshold value based on the quantization parameter will bind the absolute difference between the pixels value of the pixel in the current line closest to the block boundary and the pixel value of the pixel in the corresponding current line in the neighboring block closest to the block boundary to the value t_{c}.

The determination of the third threshold is actually only needed once for the block. This means that step S20 can advantageously be conducted between steps S1 and S2 in FIG. 1, in parallel with step S1 or indeed prior step S1 instead of following step S2 as indicated in FIG. 5.

FIG. 6 is a corresponding flow diagram illustrating a step of determining the first threshold and the second threshold to be used in connection with the first and second filter decision values. Step S30 determines the first threshold and the second threshold based on the quantization parameter selected for the current block. Furthermore, the second threshold is preferably determined to be equal to half the first threshold. In a particular embodiment, T₁=β>>2 and T₂=β>>3, where the parameter β is determined based on the quantization parameter (QP) of the block. Table 1 below defines possible values of t_{c} and β for different possible quantization parameter values.

TABLE 1
Relation between QP, t_{c} and β

| | QP | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| t_{c} | 0 | 0 | 0 | 0 | 0 | 0 | 0 | 0 | 0 | 0 | 0 | 0 | 0 | 0 | 0 |
| β | 0 | 0 | 0 | 0 | 0 | 0 | 0 | 0 | 0 | 0 | 0 | 0 | 0 | 0 | 0 |
| | QP | | | | | | | | | | | | | | |
| | 15 | 16 | 17 | 18 | 19 | 20 | 21 | 22 | 23 | 24 | 25 | 26 | 27 | 28 | 29 |
| t_{c} | 0 | 0 | 0 | 1 | 1 | 1 | 1 | 1 | 1 | 1 | 1 | 1 | 2 | 2 | 2 |
| β | 0 | 6 | 7 | 9 | 9 | 10 | 11 | 12 | 13 | 14 | 15 | 16 | 17 | 18 | 20 |
| | QP | | | | | | | | | | | | | | |
| | 30 | 31 | 32 | 33 | 34 | 35 | 36 | 37 | 38 | 39 | 40 | 41 | 42 | 43 | 44 |
| t_{c} | 2 | 3 | 3 | 3 | 3 | 4 | 4 | 4 | 5 | 5 | 6 | 6 | 7 | 8 | 9 |
| β | 22 | 24 | 26 | 28 | 30 | 32 | 34 | 36 | 38 | 40 | 42 | 44 | 46 | 48 | 50 |

| | QP | | | | | | | | | | |
|---|---|---|---|---|---|---|---|---|---|---|---|
| | 45 | 46 | 47 | 48 | 49 | 50 | 51 | 52 | 53 | 54 | 55 |
| t_{c} | 9 | 10 | 10 | 11 | 11 | 12 | 12 | 13 | 13 | 14 | 14 |
| β | 52 | 54 | 56 | 58 | 60 | 62 | 64 | | | | |

In such a case, a single look-up table, such as Table 1, can be used to derive all the threshold values employed in the three filter decisions using a single input, i.e. the quantization parameter determined for the current block.

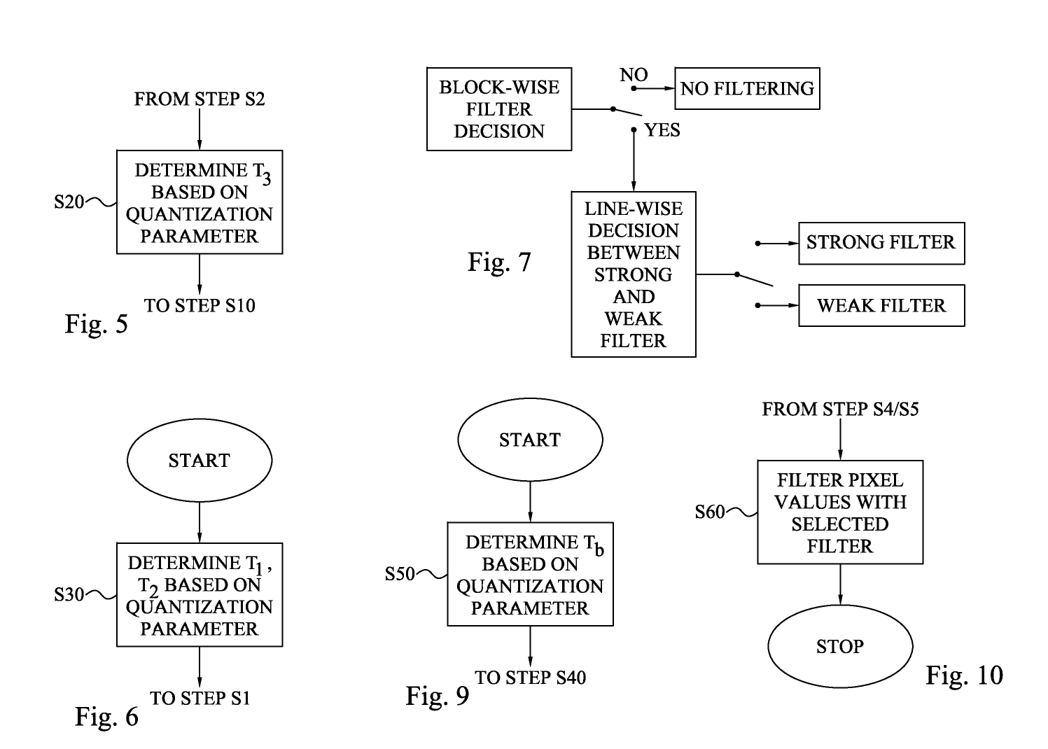

The above described two or preferably three filter decisions are employed to select whether to use strong filtering or weak filtering for a current line of pixels in the block. These filter decisions are preferably accompanied by a filter decision used to determine whether any filtering is to be applied at all. Such an additional filter decision could be a line-based filter decision in similarity to the second and third filter decisions. However, doing such a line-based filter decision whether to filter or not for each line can sometimes be regarded as too computationally complex. In such a case, it could be more advantageous to use a block-based or block-wise filter decision that applies to all lines in the block and for the current block boundary. FIG. 7 illustrates this concept. A first block-wise filter decision is calculated once for the block and the relevant block boundary. This block-wise filter decision is employed to decide whether to conduct de-blocking filtering for the block and the block boundary or not conduct any de-blocking filtering for the block and the block boundary. Once this block-wise filter decision has been taken and if it concluded that de-blocking filtering should be performed the line-wise filter decisions, i.e. first and second filter decisions and preferably first, second and third filter decisions, are employed to select whether a current line should be filtered with a strong de-blocking filter or a weak de-blocking filter.

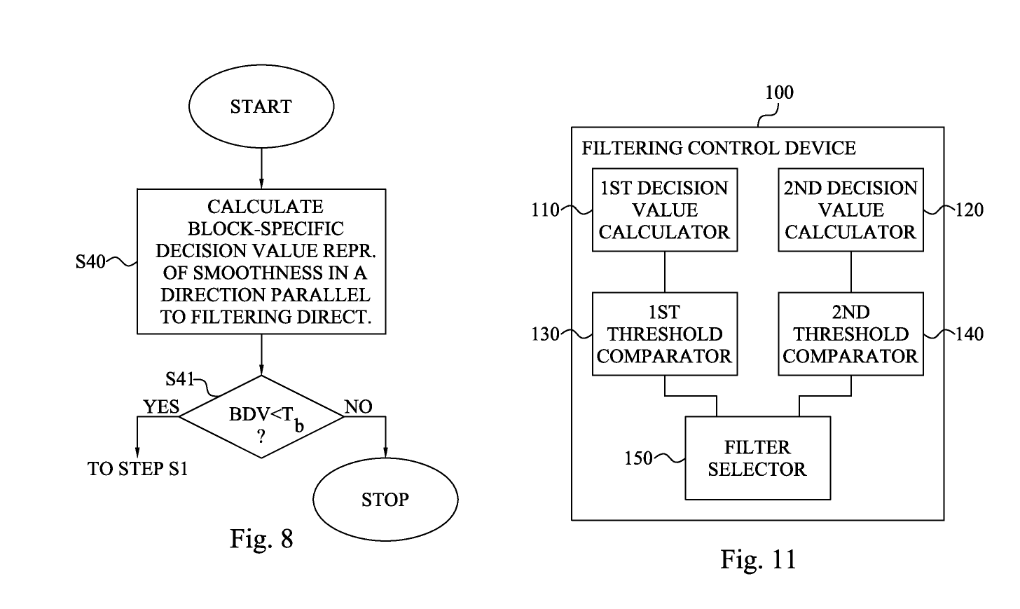

FIG. 8 is a flow diagram illustrating such block-wise or block-specific filter decision. The method starts in step S40, which calculates a block-specific decision value for the current block and the relevant block boundary. The calculated block-specific decision value is representative of how smooth pixel values in the first line of pixels in the block and in the corresponding first line of pixels in the neighboring block are in a direction parallel to the filtering direction and how smooth pixel values in the second line of pixels in the block and in the corresponding second line of pixel in the neighboring block are in a direction parallel to the filtering direction. A next step S41 compares the block-specific decision value calculated in step S40 with a block-specific threshold (T_{b}). If the block-specific decision value is not below the block-specific threshold the method ends and no de-blocking filtering is to be conducted for the current block and the relevant block boundary. However, if the block-specific decision value is below the block-specific threshold de-blocking filtering is to be applies to the block and the method continues to step S1 of FIG. 1, where the decision is made between strong and weak de-blocking filtering.

In a particular embodiment, the block-specific filter decision value calculated in step S40 is equal to the first filter decision value previously described. The above described embodiments for the first filter decision value can therefore also apply to the block-specific filter decision value. Hence, in a particular embodiment the block-specific filter decision value is calculated as |p2₂−2p1₂+p0₂|+|q2₂−2q1₂+q0₂|+|p2₅−2p1₅+p0₅|+|q2₅−2q1₅+q0₅|. However, even if the block-specific filter decision value is preferably calculated to be equal to the first filter decision value, the block-specific threshold does not need to be equal to the first threshold, and is preferably not equal to the first threshold.

FIG. 9 is a flow diagram illustrating a method of determining the block-specific threshold. The method starts in step S50 where the block-specific threshold is determined based on the quantization parameter determined for the current block. In a particular embodiment, the block-specific threshold is determined from a look-up table, such as Table 1 above, based on the quantization parameter selected for residual coding of the block.

An embodiment of step S50 determines the block-specific threshold based on the quantization parameter. The first threshold is then preferably determined to be equal to one fourth of the block-specific threshold and the second threshold is preferably determined to be equal to one eight of the block-specific threshold. In a particular embodiment, T_{b}=β, T₁=β>>2 and T₂=β>>3, where β is selected based on the quantization parameter, such as defined in Table 1.

In an embodiment, additional conditions or criteria can be used in addition to the block-specific filter decision in order to decide whether a block boundary between a current block A and a neighboring block B should be filtered. Examples of such additional conditions include:
i) block A or block B has prediction mode (PredMode) equal to intra (MODE_INTRA);
ii) block A or block B has nonzero transform coefficients;
iii) block A or block B use different reference frames or different number of motion vectors;
iv) one motion vector is used to predict block A and one motion vector is used to predict block B and the absolute difference between the horizontal or vertical component of the motion vectors used is greater than or equal to four in units of quarter luma frame samples;
v) two motion vectors and two different reference pictures are used to predict block A and two motion vectors for the same two reference pictures are used to predict block B and the absolute difference between the horizontal or vertical component of the two motion vectors used in the prediction of the two blocks for the same reference picture is greater than or equal to four in units of quarter luma frame samples;
vi) two motion vectors for the same reference picture are used to predict block A and two motion vectors for the same reference picture are used to predict block B and the absolute difference between the horizontal or vertical component of the corresponding motion vectors used in the prediction of the two partitions is greater than or equal to four in units of quarter luma frame samples.

The above presented conditions i) to vi) are preferably alternatives. This means that if any of the conditions i) to vi) are met for a current block A and if the block-specific filter decision is true, de-blocking filtering should be applied over the block boundary and a strong or weak de-blocking filter should be selected for each line of pixels in the block. This also implies that if none of the conditions i) to vi) are met for a current block A, no de-blocking filtering is preferably conducted for block A and the relevant boundary.

FIG. 10 is a flow diagram illustrating an additional step of the method illustrated in FIG. 1. The method continues from step S4 or S5 in FIG. 1. A next step S60 filters pixel values in the current lines of pixels with the selected de-blocking filter. This means that if the method continues from step S4 in FIG. 1, step S60 filters the pixel values with a strong de-blocking filter.

The embodiments can be applied in connection with any strong de-blocking filter employed in the art to combat blocking artifacts. In a particular embodiment, the strong de-blocking filtering is performed with the following set of operations:

p0ᵢ′=(p2ᵢ+2p1ᵢ+2p0ᵢ+2q0ᵢ+q1ᵢ+4)>>3

p1ᵢ′=(p2ᵢ+p1ᵢ+p0ᵢ+q0ᵢ+2)>>2

p2ᵢ=(2p3ᵢ+3p2ᵢ+p1ᵢ+p0ᵢ+q0ᵢ+4)>>3

q0ᵢ′=(p1ᵢ+2p0ᵢ+2q0ᵢ+2q1+q2ᵢ+4)>>3

p1ᵢ′=(p0ᵢ+q0ᵢ+q1ᵢ+q2ᵢ+2)>>2

q2ᵢ′=(p0ᵢ+q0ᵢ+q1ᵢ+3q2ᵢ+2q3ᵢ+4)>>3

where i represents the current line in the block. Hence, with reference to the blocks in FIGS. 2A and 2B i=0 . . . 7. In the equations above pkᵢ′ qkᵢ′, k=0 . . . 2, represent the modified pixel values in the block and the neighboring block respectively, after filtering.

The modified pixel values are preferably also clipped to be forced to be within an allowed pixel value range. In a particular embodiment, the clipping operation forces the modified pixel values to be present within the range of [0, 255], allowing 256 different pixel values. This means that if the modified pixel value after filtering is smaller than 0 or larger than 255 it is replaced by 0 or 255, respectively.

If the comparison in step S3 of FIG. 1 instead results in that the method continues to step S5 of FIG. 1, step S60 filters the pixel values with a weak de-blocking filter.

The embodiments can be applied in connection with any weak de-blocking filter employed in the art to combat blocking artifacts. In a particular embodiment, the weak de-blocking filtering is performed with the following set of operations:

p0ᵢ′=p0ᵢ+Δ₀

q0ᵢ′=q0ᵢ−Δ₀

The value Δ₀ is calculated in a two-step process with the calculation of an initial Δ₀i value, followed by clipping of this value before it is applied to the equations above. In a particular embodiment, Δ₀i=(p1ᵢ−4p0ᵢ+4q0ᵢ−qᵢ+4)>>3. The impulse response of the weak de-blocking filter is (1, 4, 4-1)/8. The clipping range of Δ₀i is determined based on the quantization parameter of the block.

In this embodiment, the values p1ᵢ, q1ᵢ are modified if additional filter conditions are met otherwise the pixel values are not modified. In an embodiment, p1ᵢ is modified if |p2ᵢ−p0ᵢ|<T₄, where T₄ represents a fourth threshold and is preferably determined based on the quantization parameter of the block. If this condition is true, p1ᵢ′=p1ᵢ+Δₚ₁. The value Δₚ₁ is also calculated in a two-step process starting with calculating an initial value Δₚ₁ᵢ=(p2ᵢ+((p0ᵢ+q0ᵢ+1)>>1)−2p1ᵢ)>>1. The corresponding impulse response is (1, 0, 0.5, 0.5)/2. Δₚ₁ is then determined as Δₚ₁=Min(Max(−t_{c}, Δₚ₁ᵢ),t_{c}), where t_{c}, is determined based on the quantization parameter of the block and could be determined from a look-up table, such as Table 1 above.

Correspondingly, q1ᵢ is modified if |q2ᵢ−q0ᵢ|<T₄. If this condition is true, q1ᵢ′=q1ᵢ+Δ_{q1}. The value Δ_{q1} is also calculated in a two-step process starting with calculating an initial value Δ_{q1i}=(q2ᵢ+((q0ᵢ+p0ᵢ+1)>>1)−2q1ᵢ)>>1 with impulse response (0.5, 0.5, 0, 1)/2. Δ_{q1} is then determined as Δ_{q1}=Min(Max(−t_{c}, Δ_{q1i}),t_{c}).

In an embodiment, the clipping range for Δ₀i is determined based on the value t_{C} and the evaluation of the conditions |p2ᵢ−p0ᵢ|<T₄ and |q2ᵢ−q0ᵢ|<T₄. In such a case, a clipping value t_{C}′ is first set equal to t_{C} and is then incremented by one for each of the conditions |p2ᵢ−p0ᵢ|<T₄ and |q2ᵢ−q0ᵢ|<T₄ that are met. In an embodiment, Δ₀=Min(Max(−t_{C}′,Δ₀ᵢ),t_{C}′.

In an alternative embodiment, Δₚ₁ᵢ=(((((p0ᵢ+q0ᵢ+1)>>1)+p2ᵢ+1)>>1)−p1ᵢ)>>1 and Δ_{g1i}=(((((p0ᵢ+q0ᵢ+1)>>1)+q2ᵢ+1)>>1)−q1ᵢ)>>1. The impulse responses are (2, 4, 1, 1)/8 and (1, 1, 4, 2)/8. This filtering provides better interpolation properties for the pixel values p2ᵢ,q2ᵢ compared to using a filter with filter taps (1, 0, 0.5, 0.5)/2. This also reduces the risk of unintentionally introducing artificial edges.

In another embodiment, the weak filtering is performed according to the following operations:

Δ=Clip(−t_{C},t_{C},(13(q0ᵢ−p0ᵢ)+4(q1ᵢ−p1ᵢ)−5(q2ᵢ−p2ᵢ)>>5))

p0ᵢ′=Clip(0,255,(p0ᵢ+Δ))

q0ᵢ′=Clip(0,255,(q0ᵢ−Δ))

p1ᵢ′=Clip(0,255,(p1ᵢ+Δ/2))

q1ᵢ′=Clip(0,255,(q1ᵢ−Δ/2))

where Clip(a,b,X)=Min(Max(a,X),b).

FIG. 11 is a schematic block diagram of a filtering control device 100 according to an embodiment. The filtering control device 100 comprises a first decision value calculator 110 configured to calculate a first filter decision value for a block of multiple pixels in a video frame. The first decision value calculator 110 calculates a first filter decision value that is representative of how smooth pixel values in a first line of pixel in the block and in a corresponding first line of pixels in the neighboring block are in a direction parallel to a filtering direction.

A first threshold comparator 130 is configured to compare the first filter decision value calculated by the first decision value calculator 110 with a first threshold.

A second decision value calculator 120 is implemented in the filtering control device 100 to calculate a second filter decision value for the block representative of how close pixel values in a current line of pixels in the block approximate a flat line and how close pixel values in a corresponding current line of pixels in the neighboring block approximate a flat line.

The second filter decision value calculated by the second decision value calculator 120 is compared to a second threshold by a second threshold comparator 140.

The filtering control device 100 additionally comprises a filter selector 150 configured to select a strong de-blocking filter to filter at least one pixel value in the current line of pixels if the first filter decision value is below the first threshold as determined by the first threshold comparator 130 and if the second filter decision value is below the second threshold as determined by the second threshold comparator 140. Otherwise the filter selector 150 is configured to select a weak de-blocking filter to filter at least one pixel value in the current line of pixels.

The filtering control device 100 thereby operates on and investigates each line of pixels for a current block boundary. This means when moving to a second or new current line of pixels in the block, the second decision value calculator 120 calculates a new second filter decision value. However, the first decision value calculator 110 preferably does not need to calculate a new first filter decision value. In clear contrast, one and the same first filter decision value is preferably applicable to and can be used for all lines of pixels in the block and with regard to the relevant block boundary.

The first and second decision value calculators 110, 120 can be configured to calculate the first and second filter decision values, respectively, according to any of the previously discussed embodiments. For instance, the second decision value calculator 120 advantageously calculates the second filter decision value as |p3ᵢ−p0ᵢ|+|q0ᵢ−q3ᵢ|. Correspondingly, in a particular embodiment the first decision value calculator is configured to calculate the first decision value based on |p2ⱼ−2p1ⱼ+p0ⱼ|+|q2ⱼ−2q1ⱼ+q0ⱼ| and preferably calculate the first filter decision value as |p2₂−2p1₂+p0₂|+|q2₂−2q1₂+q0₂|+|p2₅−2p1₅+p0₅|+|q2₅−2q1₅+q0₅|.

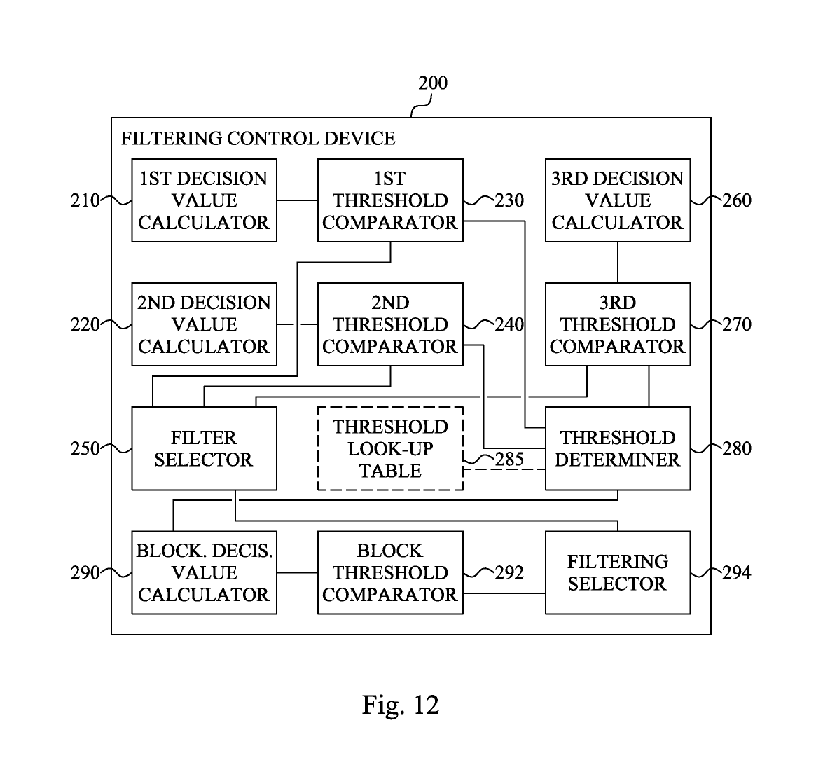

FIG. 12 is a schematic block diagram of another embodiment of a filtering control device 200. The operations of the first decision value comparator 210, the first threshold comparator 230, the second decision value calculator 220 and the second threshold comparator 240 are basically the same as the above-described embodiment illustrated in FIG. 11. These units 210, 220, 230, 240 of the filtering control device 200 are therefore not discussed further.

The filtering control device 200 comprises a third decision value calculator 260 configured to calculate a third filter decision value for the block. The third filter decision value is representative of an absolute difference between the pixel value of the pixel in the current line closest to the block boundary and the pixel value of the pixel in the corresponding current line closest to the block boundary, i.e. |p0ᵢ−q0ᵢ|. A third threshold comparator 270 is implemented in the filtering control device 200 to compare the third filter decision value calculated by the third decision value calculator with a third threshold. The filter selector 250 is then configured to select the strong de-blocking filter if the first filter decision value is below the first threshold, the second filter decision value is below the second threshold and if the third filter decision value is below the third threshold as determined by the third threshold comparator 270. If not all of these conditions are met, the filter selector 250 instead selects a weak de-blocking filter to filter at least one pixel value in the current line of pixels.

The filtering control device 200 preferably comprises a threshold determiner 280 configured to determine the first, second and third threshold employed by the first, second and third threshold comparators 230, 240, 270, respectively. In a particular embodiment, the threshold determiner determines the three thresholds for the block based on the quantization parameter selected for residual coding of the block.

In a particular embodiment, the threshold determiner 280 is configured to determine the third threshold to be a₁×t_{c} as previously described, and preferably to be 2.5t_{c}. The threshold determiner 280 additionally preferably determines the second threshold to be equal to half the threshold and advantageously to be T₁=β>>2 and T₂=β>>3. The values t_{c},β are preferable dependent on the quantization parameter of the block and are preferably determined by the threshold determiner 280 based on a threshold look-up table 285 using the quantization parameter as input.

In an embodiment, the filtering control device 200 also or additionally comprises a block decision value calculator 290 configured to calculate a block decision value for the block. The block decision value is preferably representative of how smooth pixel values in the first and the second line of pixels in the block and in the corresponding first and the corresponding second line of pixels in the neighboring block are in a direction parallel to the filtering direction. The block decision value calculated by the block decision value calculator 290 is advantageously equal to the first filter decision value calculated by the first decision value calculator 210. In such a case, the block decision value calculator 290 could be omitted and its operation is instead taken over by the first decision value calculator 210. However, it is possible to have both these units 210, 290 implemented in the filtering control device 200 and in particular for those embodiments where the block-specific decision value is not necessarily equal to the first filter decision value.

In either case, the block-specific decision value calculated by the block decision value calculator 290 or coming from the first decision value calculator 210 is processed by a block threshold comparator 292. The block threshold comparator 292 in particular compares the block-specific decision value to a block-specific threshold. A filtering selector 294 is then implemented in the filtering control device 200 to select whether to apply de-blocking filter to the current block and the relevant block boundary or not based on the comparison conducted by the block threshold comparator 292. The filtering selector 294 preferably selects to apply de-blocking filtering to the block if the block-specific decision value is below the block-specific threshold as determined by the block threshold comparator 292. If the block-specific decision value is not below the block-specific threshold the filtering selector 294 prevents any de-blocking filtering for the current block and the current block boundary.

The threshold determiner 280 previously discussed preferably also determines the block-specific threshold employed by the block threshold comparator 292. The threshold determiner 280 preferably determines the block-specific threshold based on the quantization parameter of the block and preferably using the threshold look-up table 285 with the quantization parameter as table input.

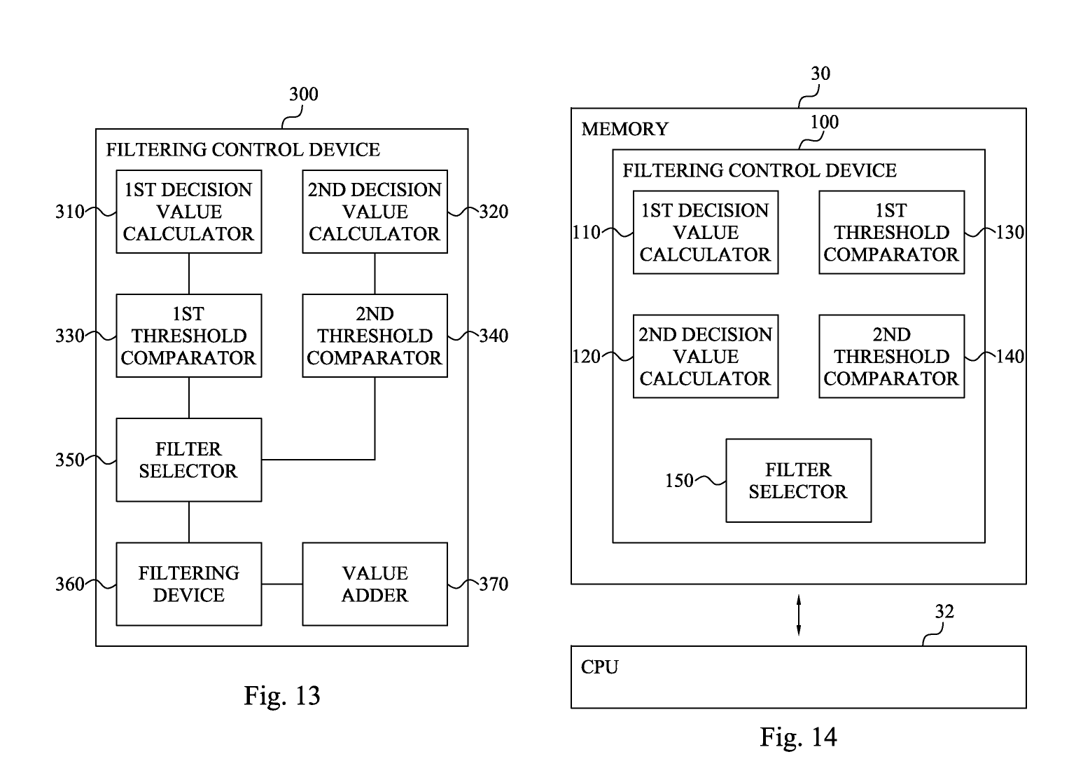

FIG. 13 is a schematic block diagram of yet another embodiment of a filtering control device 300. The operations of the first and second decision value calculators 310, 320, the first and second threshold comparators 330, 340 and the filter selector 350 are preferably conducted as previously described above in connection with FIGS. 11 and 12.

In this embodiment, the filtering control device 300 comprises a filtering device configured to filter pixel values in the current line of pixels with a de-blocking filter selected by the filter selector. The filtering device 360 can be configured to apply any of the previously described and discussed strong or weak de-blocking filters.

In a particular embodiment, the filtering device 360, when the filter selector 350 indicates selection of weak de-blocking filtering, filter pixel values in the current line of pixels with a weak de-blocking filter having filter taps [2 4 1 1]/8 to get a delta value. A value adder 370 is in this embodiment implemented in the filtering control device 300 to add the delta value to the pixel value of a pixel closest to, in the current line of pixels, the block boundary.

The embodiments described above and illustrated in FIGS. 11 to 13 can be combined. Thus, the filtering device and value adder of FIG. 13 can be implemented in the filtering control device of FIG. 11 or 12. Additionally, the third decision value calculator and third threshold comparator of FIG. 12 can be implemented in the embodiments of FIG. 11 or 13. Alternatively, or in addition the block decision value calculator, the block threshold comparator and the filtering selector could be provided in the embodiments of FIG. 11 or 13 as could the threshold determiner and the threshold look-up table.

Any of the embodiments of the filtering control device could be implemented at least partly in software. FIG. 14 is a schematic block diagram of the filtering control device 100 implemented as a computer program product stored on a memory 26 and loaded and run on a general purpose or specially adapted computer, processor or microprocessor, represented by a central processing unit (CPU) 32 in the figure.

The software includes computer program code elements or software code portions effectuating the operation of at least the first decision value calculator 110, the second decision value calculator 120, the first threshold comparator 130, the second threshold comparator 140 and the filter selector 150. The units or devices as illustrated in FIGS. 12 and 13 may also be implemented as computer program code elements stored in the memory 30 and executed by the CPU 32. The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the filtering control device 100 include single instruction multiple data (SIMD) code.

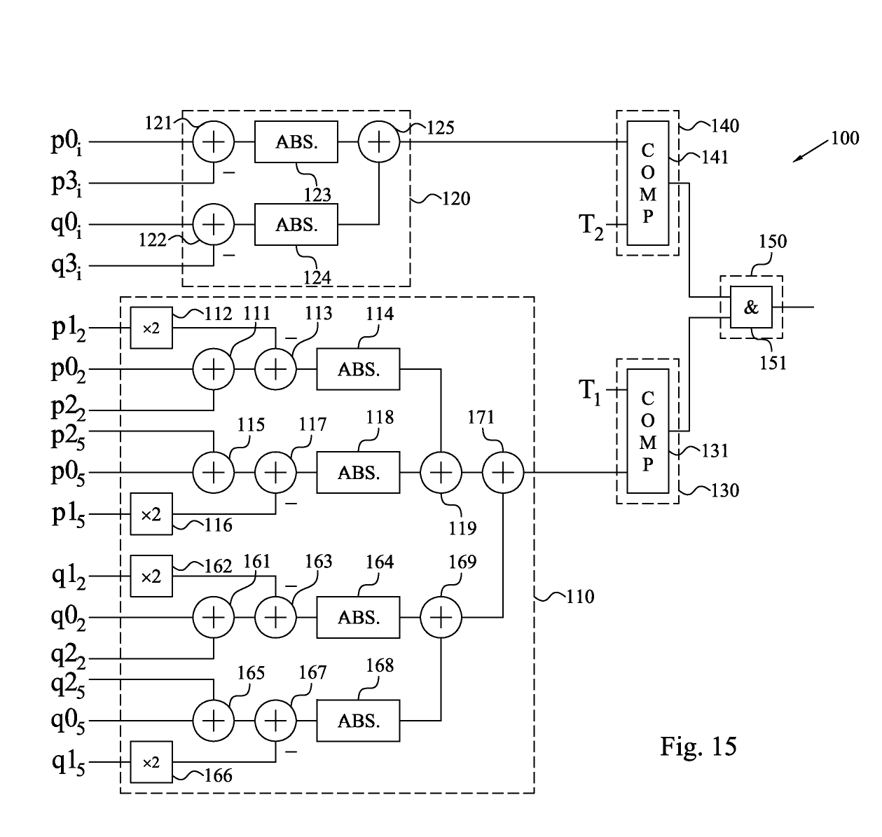

FIG. 15 is an illustration of a hardware implementation of a filtering control device according to an embodiment. In this embodiment, the second decision value calculator 120 is implemented as three adders 121, 122, 125 and two absolute value calculators 123, 124. A first adder 121 receives the pixel value of the pixel in the current line of pixels closest to the block boundary and the negated pixel value of the pixel in the current line third closest to the block boundary. A second adder 122 correspondingly receives the pixel value of the pixel in the corresponding current line of pixels closest to the block boundary and the negated pixel value of the pixel in the corresponding current line third closest to the block boundary. The output from the first adder 121 is brought to a first absolute value calculator 123 that provides a positive value. A second absolute value calculator 124 correspondingly provides a positive value of the output from the second adder 122. The third adder 125 then sums the positive values from the two absolute value calculators 123, 124 to get the second filter decision value.

The first filter decision value calculator 110 comprises, in this embodiment, a first adder 111 that adds the pixel values of the pixel closest to and second next closest to the block boundary in the first line of pixels. The pixel value of the pixel next closest to the block boundary in the first line is multiplied by two in a multiplier 112 and the output from the multiplier 112 is negated and is input to a second adder 113 which also receives the output from the first adder. A first absolute value calculator 114 generates a positive value of the adder output.

A corresponding pair of adders 115, 117, a multiplier 116 and an absolute value calculator 118 operates on the pixel values in the second line of pixels in the current block. The outputs from the first absolute value calculator 114 and the second absolute value calculator 118 are summed by an adder 119.

A corresponding set of adders 161, 163, 165, 167, 169, multipliers 162, 166 and absolute value calculators 164, 168 are interconnected and configured to operate on pixel values of pixels in the corresponding first and second lines of pixels in the neighboring block. Finally, an adder 171 sums the output from the circuitry processing pixel values of the first and second lines in the block and the output from the circuitry processing pixel values of the corresponding first and second lines in the neighboring block.

The first threshold comparator 130 is implemented as a comparator 131 that receives the output from the adder 171 and the value of the first threshold. The comparator 131 outputs 1_{bin} if the adder output is below the first threshold and otherwise outputs 0_{bin}. The second threshold comparator 140 is also implemented as a comparator 141 that receives the output from the adder 125 of the second decision value calculator 120 and the second threshold. The comparator 141 outputs 1_{bin} if the adder output is below the first threshold and otherwise outputs 0_{ban}.

The outputs from the two comparators 131, 141 are input to an AND gate 151, which corresponds to the filter selector 150. If both the comparator outputs are 1_{bin}, the AND gate 151 outputs 1_{bin}, indicating that strong de-blocking filtering is to be applied to pixel values in the current line of pixels in the block. Otherwise the AND gate 151 outputs 0_{bin} and weak de-blocking filtering will instead be applied to the pixel values.

The hardware implementation of the filtering control device 100 illustrated in FIG. 15 should merely be seen as an illustrative example of how the units 110, 120, 130, 140, 150 of the filtering control device 100 can be implemented in hardware. There are numerous variants of circuitry elements that can be used and combined to achieve the same or corresponding functions as the circuitry elements illustrated in the figure. Also such variants are encompassed by the embodiments. Particular examples of hardware implementation of the filtering control device 100 is implementation in digital signal processor (DSP) hardware and integrated circuit technology, including both general-purpose electronic circuitry and application-specific circuitry.

FIG. 13 is a schematic block diagram of an encoder 40 for encoding a block of pixels in a video frame of a video sequence according to an embodiment.

A current block of pixels is predicted by performing a motion estimation by a motion estimator 50 from an already provided block of pixels in the same frame or in a previous frame. The result of the motion estimation is a motion or displacement vector associated with the reference block, in the case of inter prediction. The motion vector is utilized by a motion compensator 50 for outputting an inter prediction of the block of pixels.

An intra predictor 49 computes an intra prediction of the current block of pixels. The outputs from the motion estimator/compensator 50 and the intra predictor 49 are input in a selector 51 that either selects intra prediction or inter prediction for the current block of pixels. The output from the selector 51 is input to an error calculator in the form of an adder 41 that also receives the pixel values of the current block of pixels. The adder 41 calculates and outputs a residual error as the difference in pixel values between the block of pixels and its prediction.

The error is transformed in a transformer 42, such as by a discrete cosine transform, and quantized by a quantizer 43 followed by coding in an encoder 44, such as by entropy encoder. In inter coding, also the estimated motion vector is brought to the encoder 44 for generating the coded representation of the current block of pixels.

The transformed and quantized residual error for the current block of pixels is also provided to a inverse quantizer 45 and inverse transformer 46 to retrieve the original residual error. This error is added by an adder 47 to the block prediction output from the motion compensator 50 or the intra predictor 49 to create a reference block of pixels that can be used in the prediction and coding of a next block of pixels. This new reference block is first processed by a filtering control device 100 according to the embodiments in order to determine whether de-blocking filtering will be applied and in such a case what type of de-blocking filter to use. The processed new reference block is then temporarily stored in a frame buffer 48, where it is available to the intra predictor 49 and the motion estimator/compensator 50.

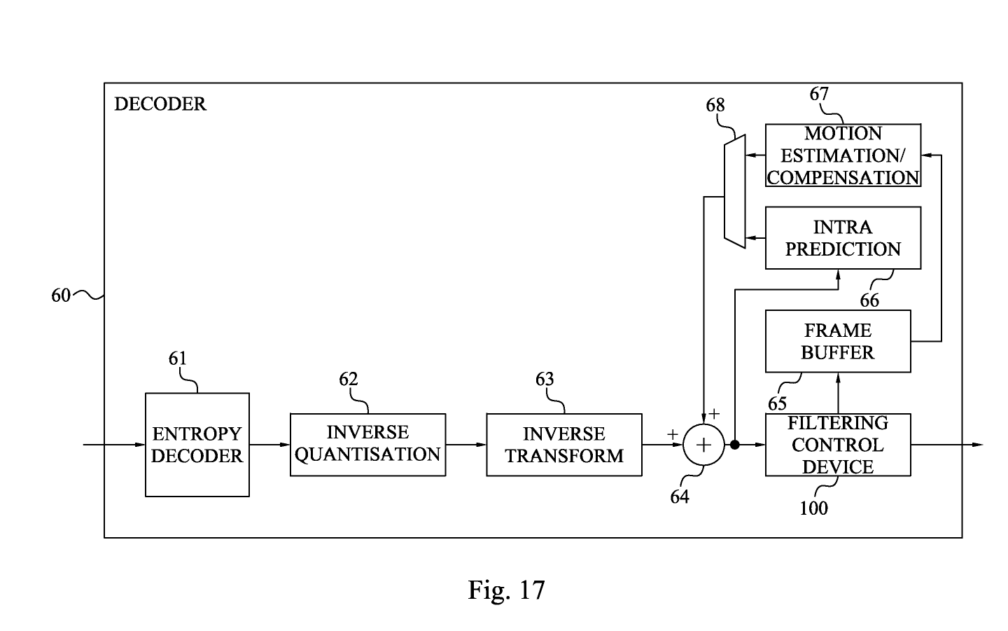

FIG. 17 is a corresponding schematic block diagram of a decoder 60 comprising a filtering control device 100 according to the embodiments. The decoder 60 comprises a decoder 61, such as entropy decoder, for decoding an encoded representation of a block of pixels to get a set of quantized and transformed residual errors. These residual errors are dequantized in an inverse quantizer 62 and inverse transformed by an inverse transformer 63 to get a set of residual errors.

These residual errors are added in an adder 64 to the pixel values of a reference block of pixels. The reference block is determined by a motion estimator/compensator 67 or intra predictor 66, depending on whether inter or intra prediction is performed. A selector 68 is thereby interconnected to the adder 64 and the motion estimator/compensator 67 and the intra predictor 66. The resulting decoded block of pixels output form the adder 64 is input to a filtering control device 100 according to the embodiments in order to de-blocking filter any blocking artifacts. The filtered block of pixels is output form the decoder 60 and is furthermore preferably temporarily provided to a frame buffer 65 and can be used as a reference block of pixels for a subsequent block of pixels to be decoded. The frame buffer 65 is thereby connected to the motion estimator/compensator 67 to make the stored blocks of pixels available to the motion estimator/compensator 67.

The output from the adder 64 is preferably also input to the intra predictor 66 to be used as an unfiltered reference block of pixels.

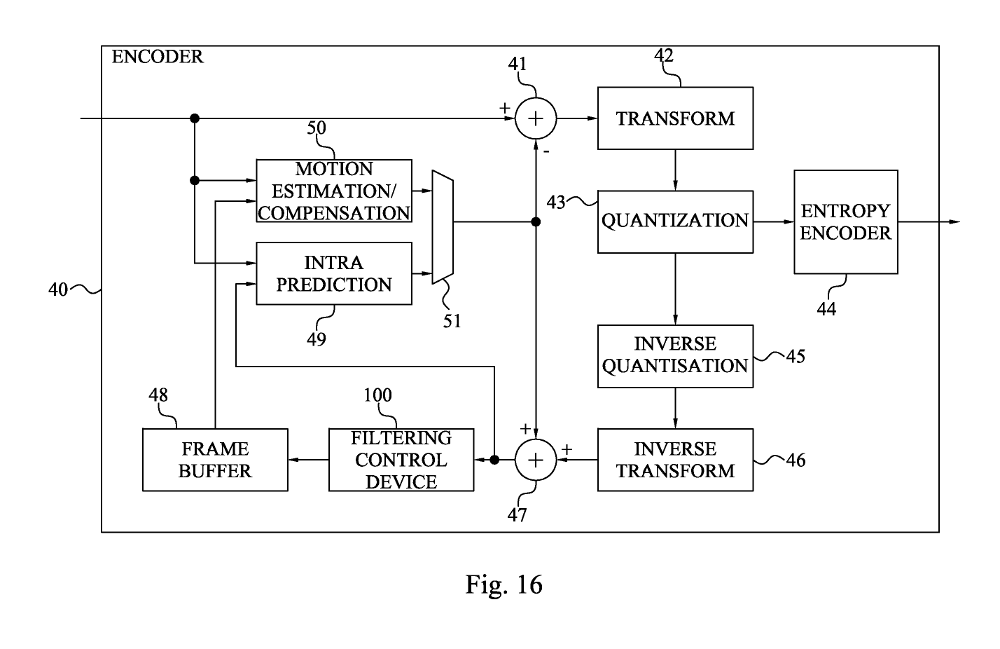

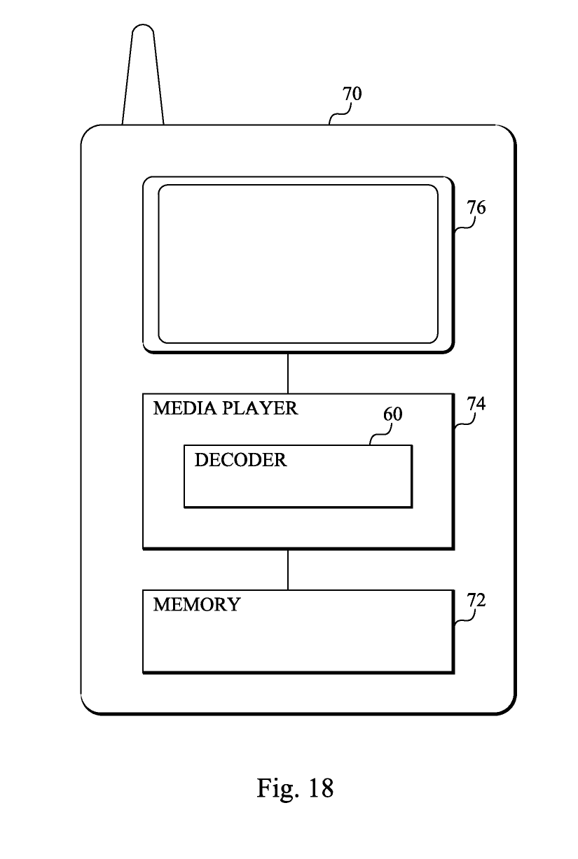

FIG. 18 is a schematic block diagram of a media terminal 70 housing a decoder 60 with a filtering control device. The media terminal 70 can be any device having media decoding functions that operates on an encoded video stream of encoded video frames to thereby decode the video frames and make the video data available. Non-limiting examples of such devices include mobile telephones and other portable media players, computers, decoders, game consoles, etc. The media terminal 70 comprises a memory 72 configured to store encoded video frames. These encoded video frames can have been generated by the media terminal 70 itself. In such a case, the media terminal 70 preferably comprises a media engine or recorder together with a connected encoder, such as the encoder of FIG. 16. Alternatively, the encoded video frames are generated by some other device and wirelessly transmitted or transmitted by wire to the media terminal 70. The media terminal 70 then comprises a transceiver (transmitter and receiver) or input and output port to achieve the data transfer.

The encoded video frames are brought from the memory 72 to a decoder 60, such as the decoder illustrated in FIG. 17. The decoder 60 then decodes the encoded video frames into decoded video frames. The decoded video frames are provided to a media player 74 that is configured to render the decoded video frames into video data that is displayable on a display or screen 76 of or connected to the media terminal 70.

In FIG. 18, the media terminal has been illustrated as comprising both the decoder 60 and the media player 74, with the decoder 60 implemented as a part of the media player 74. This should, however, merely be seen as an illustrative but non-limiting example of an implementation embodiment for the media terminal 70. Also distributed implementations are possible where the decoder 60 and the media player 74 are provided in two physically separated devices are possible and within the scope of media terminal 70 as used herein. The display 76 could also be provided as a separate device connected to the media terminal 70, where the actual data processing is taking place.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A filtering control method applicable to a block of multiple pixels in a video frame, each pixel having a respective pixel value, said method comprising:
calculating a first filter decision value for said block representative of how smooth pixel values in a first line of pixels in said block and in a corresponding first line of pixels in a neighboring block of multiple pixels in said video frame are in a direction parallel to a filtering direction;
calculating a second filter decision value for said block representative of how close pixel values in a current line of pixels in said block approximate a flat line and how close pixel values in a corresponding current line of pixels in said neighboring block approximate a flat line;
comparing said first filter decision value with a first threshold and said second filter decision value with a second threshold;
selecting a strong de-blocking filter to filter at least one pixel value in said current line of pixels if said first filter decision value is below said first threshold and said second filter decision value is below said second threshold and otherwise selecting a weak de-blocking filter to filter at least one pixel value in said current line of pixels, wherein said strong de-blocking filter has a comparatively higher filtering strength as compared to said weak de-blocking filter.

2. The method according to claim 1, wherein calculating said second filter decision value comprises calculating said second filter decision value as

|p3ᵢ−p0ᵢ|+|q0ᵢ−q3ᵢ|

where p0ᵢ denotes a pixel value of a pixel closest to, in said current line of pixels, a block boundary to said neighboring block, p3ᵢ denotes a pixel value of a pixel third next closest to, in said current line of pixels, said block boundary, q0ᵢ denotes a pixel value of a pixel in said neighboring block closest to, in said corresponding current line of pixels, said block boundary and q3ᵢ denotes a pixel value of a pixel in said neighboring block third next closest to, in said corresponding current line of pixels, said block boundary.

3. The method according to claim 1, wherein calculating said first filter decision value comprises calculating said first filter decision value based on

|p2ⱼ−2p1ⱼ+p0ⱼ|+|q2ⱼ−2q1ⱼ+q0ⱼ|

where p0ⱼ denotes a pixel value of a pixel closest to, in said first line of pixels in said block, a block boundary to said neighboring block, p1ⱼ denotes a pixel value of a pixel next closest to, in said first line of pixels, said block boundary, p2ⱼ denotes a pixel value of a pixel second next closest to, in said first line of pixels, said block boundary, q0ⱼ denotes a pixel value of a pixel in said neighboring block closest to, in said corresponding first line of pixels in said neighboring block, said block boundary, q1ⱼ denotes a pixel value of a pixel of said neighboring block next closest to, in said corresponding first line of pixels, said block boundary and q2ⱼ denotes a pixel value of a pixel in said neighboring block second next closest to, in said corresponding first line of pixels, said block boundary.

4. The method according to claim 3, wherein calculating said first filter decision value comprises calculating said first filter decision value as

|p2₂−2p1₂+p0₂|+|q2₂−2q1₂+q0₂|+|p2₅−2p1₅+p0₅|+|q2₅−2q1₅+q0₅|

where p0₂ denotes said pixel value of said pixel closest to, in said first line of pixels, said block boundary, p1₂ denotes said pixel value of said pixel next closest to, in said first line of pixels, said block boundary, p2₂ denotes said pixel value of said pixel second next closest to, in said first line of pixels, said block boundary, q0₂ denotes said pixel value of said pixel in said neighboring block closest to, in said corresponding first line of pixels, said block boundary, q1ⱼ denotes said pixel value of said pixel of said neighboring block next closest to, in said corresponding first line of pixels, said block boundary, q2₂ denotes said pixel value of said pixel in said neighboring block second next closest to, in said corresponding first line of pixels, said block boundary, p0₅ denotes a pixel value of a pixel closest to, in a second line of pixels in said block, said block boundary, p1₅ denotes a pixel value of a pixel next closest to, in said second line of pixels, said block boundary, p2₅ denotes a pixel value of a pixel second next closest to, in said second line of pixels, said block boundary, q0₅ denotes a pixel value of a pixel in said neighboring block closest to, in a corresponding second line of pixels in said neighboring block, said block boundary, q1₅ denotes a pixel value of a pixel of said neighboring block next closest to, in said corresponding second line of pixels, said block boundary and q2₅ denotes a pixel value of a pixel in said neighboring block second next closest to, in said corresponding first line of pixels, said block boundary.

5. The method according to claim 1, further comprising:
calculating a third filter decision value for said block representative of an absolute difference between a pixel value of a pixel closest to, in said current line of pixels, a block boundary to said neighboring block and a pixel value of a pixel in said neighboring block closest to, in said corresponding current line of pixels, said block boundary, wherein
comparing said first filter decision and said second filter decision comprises comparing said first filter decision value with said first threshold, said second filter decision value with said second threshold and said third filter decision value with a third threshold; and
selecting said strong de-blocking filter comprises selecting said strong de-blocking filter to filter said at least one pixel value in said current line of pixels if said first filter decision value is below said first threshold, said second filter decision value is below said second threshold and said third filter decision value is below said third threshold and otherwise selecting said weak de-blocking filter to filter said at least one pixel value in said current line of pixels.

6. The method according to claim 5, further comprising determining said third threshold based on a quantization parameter selected for residual coding of said block.

7. The method according to claim 6, wherein determining said third threshold comprises determining said third threshold as a₁×t_{c}, where t_{c} is a clipping threshold selected for said block based on said quantization parameter and a₁ is a multiplier selected to prevent selecting said strong de-blocking filter if strong filtering with said strong de-blocking filter modifies said pixel value of said pixel closest to, in said current line of pixels, said block boundary with a value that is larger than a value which weak filtering with said weak de-blocking filter and said clipping threshold will modify said pixel value of said pixel closest to, in said current line of pixels, said block boundary.

8. The method according to claim 6, wherein determining said third threshold comprises determining said third threshold as 2.5t_{c}, where t_{c} is a clipping threshold selected for said block based on said quantization parameter.

9. The method according to claim 1, further comprising determining said second threshold to be equal to half said first threshold.

10. The method according to claim 1, further comprising determining said first threshold and said second threshold based on a quantization parameter selected for residual coding of said block.

11. The method according to claim 1, further comprising:
calculating a block-specific decision value for said block representative of how smooth pixel values in said first line of pixels in said block and in said corresponding first line of pixels in said neighboring block of multiple pixels are in a direction parallel to said filtering direction and how smooth pixel values in a second line of pixels in said block and in a corresponding second line of pixels in said neighboring block of multiple pixels are in a direction parallel to said filtering direction; and
selecting to apply de-blocking filtering to said block if said block-specific decision value is below a block-specific threshold.

12. The method according to claim 11, further comprising:
determining said block-specific threshold based on a quantization parameter selected for residual coding of said block;
determining said first threshold to be equal to one fourth of said block-specific threshold; and
determining said second threshold to be equal to one eighth of said block-specific threshold.

13. The method according to claim 1, further comprising:
filtering pixel values in said current line of pixels with a weak de-blocking filter having filter taps [2 4 1 1]/8 if at least one of said first filter decision value is not below said first threshold and said second filter decision value is not below said second threshold, to thereby get a delta value; and
adding said delta value to a pixel value of a pixel closest to, in said current line of pixels, a block boundary to said neighboring block.

14. The method according to claim 1, further comprising:
calculating another second filter decision value for said block representative of how close pixel values in another current line of pixels in said block approximate a flat line and how close pixel values in another corresponding current line of pixels in said neighboring block approximate a flat line;
comparing said first filter decision value with said first threshold and said another second filter decision value with said second threshold; and
selecting said strong de-blocking filter to filter at least one pixel value in said another current line of pixels if said first filter decision value is below said first threshold and said another second filter decision value is below said second threshold and otherwise selecting said weak de-blocking filter to filter at least one pixel value in said another current line of pixels.

15. A filtering control device comprising:
a first decision value calculator configured to calculate a first filter decision value for a block of multiple pixels in a video frame, each pixel having a respective pixel value, said first filter decision value representative of how smooth pixel values in a first line of pixels in said block and in a corresponding first line of pixels in a neighboring block of multiple pixels in said video frame are in a direction parallel to a filtering direction;
a second decision value calculator configured to calculate a second filter decision value for said block representative of how close pixel values in a current line of pixels in said block approximate a flat line and how close pixel values in a corresponding current line of pixels in said neighboring block approximate a flat line;
a first threshold comparator configured to compare said first filter decision value calculated by said first decision value calculator to a first threshold;
a second threshold comparator configured to compare said second filter decision value calculated by said second decision value calculator to a second threshold; and
a filter selector configured to select a strong de-blocking filter to filter at least one pixel value in said current line of pixels if said first filter decision value is below said first threshold, as determined by said first filter threshold comparator, and said second filter decision value is below said second threshold, as determined by said second threshold comparator, and to otherwise select a weak de-blocking filter to filter at least one pixel value in said current line of pixels, wherein said strong de-blocking filter has a comparatively higher filtering strength as compared to said weak de-blocking filter.

16. The device according to claim 15, wherein said second decision value calculator is configured to calculate said second filter decision value as

|p3ᵢ−p0ᵢ|+|q0ᵢ−q3ᵢ|

where p0ᵢ denotes a pixel value of a pixel closest to, in said current line of pixels, a block boundary to said neighboring block, p3ᵢ denotes a pixel value of a pixel third next closest to, in said current line of pixels, said block boundary, q0ᵢ denotes a pixel value of a pixel in said neighboring block closest to, in said corresponding current line of pixels, said block boundary and q3ᵢ denotes a pixel value of a pixel in said neighboring block third next closest to, in said corresponding current line of pixels, said block boundary.

17. The device according to claim 15, wherein said first decision value calculator is configured to calculate said first filter decision value based on

|p2ⱼ−2p1ⱼ+p0ⱼ|+|q2ⱼ−2q1ⱼ+q0ⱼ|

where p0ⱼ denotes a pixel value of a pixel closest to, in said first line of pixels in said block, a block boundary to said neighboring block, p1ⱼ denotes a pixel value of a pixel next closest to, in said first line of pixels, said block boundary, p2ⱼ denotes a pixel value of a pixel second next closest to, in said first line of pixels, said block boundary, q0ⱼ denotes a pixel value of a pixel in said neighboring block closest to, in said corresponding first line of pixels in said neighboring block, said block boundary, q1ⱼ denotes a pixel value of a pixel of said neighboring block next closest to, in said corresponding first line of pixels, said block boundary and q2ⱼ denotes a pixel value of a pixel in said neighboring block second next closest to, in said corresponding first line of pixels, said block boundary.

18. The device according to claim 17, wherein said first decision value calculator is configured to calculate said first filter decision value as

|p2₂−2p1₂+p0₂|+|q2₂−2q1₂+q0₂|+|p2₅−2p1₅+p0₅|+|q2₅−2q1₅+q0₅|

where p0₂ denotes said pixel value of said pixel closest to, in said first line of pixels, said block boundary, p1₂ denotes said pixel value of said pixel next closest to, in said first line of pixels, said block boundary, p2₂ denotes said pixel value of said pixel second next closest to, in said first line of pixels, said block boundary, q0₂ denotes said pixel value of said pixel in said neighboring block closest to, in said corresponding first line of pixels, said block boundary, q1ⱼ denotes said pixel value of said pixel of said neighboring block next closest to, in said corresponding first line of pixels, said block boundary, q2₂ denotes said pixel value of said pixel in said neighboring block second next closest to, in said corresponding first line of pixels, said block boundary, p0₅ denotes a pixel value of a pixel closest to, in a second line of pixels in said block, said block boundary, p1₅ denotes a pixel value of a pixel next closest to, in said second line of pixels, said block boundary, p2₅ denotes a pixel value of a pixel second next closest to, in said second line of pixels, said block boundary, q0₅ denotes a pixel value of a pixel in said neighboring block closest to, in a corresponding second line of pixels in said neighboring block, said block boundary, q1₅ denotes a pixel value of a pixel of said neighboring block next closest to, in said corresponding second line of pixels, said block boundary and q2₅ denotes a pixel value of a pixel in said neighboring block second next closest to, in said corresponding first line of pixels, said block boundary.

19. The device according to claim 15, further comprising:
a third decision value calculator configured to calculate a third filter decision value for said block representative of an absolute difference between a pixel value of a pixel closest to, in said current line of pixels, a block boundary to said neighboring block and a pixel value of a pixel in said neighboring block closest to, in said corresponding current line of pixels, said block boundary; and
a third threshold comparator configured to compare said third filter decision value calculated by said third decision value calculator with a third threshold;
wherein said filter selector is configured to select said strong de-blocking filter to filter said at least one pixel value in said current line of pixels if said first filter decision value is below said first threshold as determined by said first threshold value comparator, said second filter decision value is below said second threshold as determined by said second threshold value comparator and said third filter decision value is below said third threshold as determined by said third threshold value comparator, and to otherwise select said weak de-blocking filter to filter said at least one pixel value in said current line of pixels.

20. The device according to claim 19, further comprising a threshold determiner configured to determine said third threshold based on a quantization parameter selected for residual coding of said block.

21. The device according to claim 20, wherein said threshold determiner is configured to determine said third threshold as a₁×t_{c}, where t_{c} is a clipping threshold selected for said block based on said quantization parameter and a₁ is a multiplier selected to prevent selecting said strong de-blocking filter if strong filtering with said strong de-blocking filter modifies said pixel value of said pixel closest to, in said current line of pixels, said block boundary with a value that is larger than a value which weak filtering with said weak de-blocking filter and said clipping threshold will modify said pixel value of said pixel closest to, in said current line of pixels, said block boundary.

22. The device according to claim 20, wherein said threshold determiner is configured to determine said third threshold as 2.5t_{c}, where t_{c} is a clipping threshold selected for said block based on said quantization parameter

23. The device according to claim 15, further comprising a threshold determiner configured to determine said second threshold to be equal to half said first threshold.

24. The device according to claim 15, further comprising a threshold determiner configured to determine said first threshold and said second threshold based on a quantization parameter selected for residual coding of said block.

25. The device according to claim 15, further comprising:
a block decision value calculator configured to calculate a block-specific decision value for said block representative of how smooth pixel values in said first line of pixels in said block and in said corresponding first line of pixels in said neighboring block of multiple pixels are in a direction parallel to said filtering direction and how smooth pixel values in a second line of pixels in said block and in a corresponding second line of pixels in said neighboring block of multiple pixels are in a direction parallel to said filtering direction;
a block threshold comparator configured to compare said block-specific decision value calculated by said block decision value calculator with a block-specific threshold; and
a filtering selector configured to select to apply de-blocking filtering to said block if said block-specific decision value is below said block-specific threshold as determined by said block threshold comparator.

26. The device according to claim 25, further comprising a threshold determiner configured to i) determine said block-specific threshold based on a quantization parameter selected for residual coding of said block, ii) determine said first threshold to be equal to one fourth of said block-specific threshold, and iii) determine said second threshold to be equal to one eighth of said block-specific threshold.

27. The device according to claim 15, further comprising:
a filtering device configured to filter pixel values in said current line of pixels with a weak de-blocking filter having filter taps [2 4 1 1]/8 if at least one of said first filter decision value is not below said first threshold as determined by said first threshold comparator and said second filter decision value is not below said second threshold as determined by said second threshold comparator, to thereby get a delta value; and
a value adder configured to add said delta value to a pixel value of a pixel closest to, in said current line of pixels, a block boundary to said neighboring block.

28. The device according to claim 15, wherein:
said second decision value calculator is configured to calculate another second filter decision value for said block representative of how close pixel values in another current line of pixels in said block approximate a flat line and how close pixel values in another corresponding current line of pixels in said neighboring block approximate a flat line;
said second threshold comparator is configured to compare said another second filter decision value calculated by said second decision value calculator to said second threshold; and
said filter selector is configured to select said strong de-blocking filter to filter at least one pixel value in said another current line of pixels if said first filter decision value is below said first threshold as determined by said first threshold comparator and said another second filter decision value is below said second threshold as determined by said second threshold comparator and otherwise select said weak de-blocking filter to filter at least one pixel value in said another current line of pixels.

29. The device according to claim 15, wherein said first filter decision value is representative of how close pixel values in said block approximate a plane and how close pixel values in a neighboring block of multiple pixels in said video frame approximate a plane;

30. An encoder comprising a filtering control device, the filtering control device comprising:
a first decision value calculator configured to calculate a first filter decision value for a block of multiple pixels in a video frame, each pixel having a respective pixel value, said first filter decision value representative of how smooth pixel values in a first line of pixels in said block and in a corresponding first line of pixels in a neighboring block of multiple pixels in said video frame are in a direction parallel to a filtering direction;
a second decision value calculator configured to calculate a second filter decision value for said block representative of how close pixel values in a current line of pixels in said block approximate a flat line and how close pixel values in a corresponding current line of pixels in said neighboring block approximate a flat line;
a first threshold comparator configured to compare said first filter decision value calculated by said first decision value calculator to a first threshold;
a second threshold comparator configured to compare said second filter decision value calculated by said second decision value calculator to a second threshold; and
a filter selector configured to select a strong de-blocking filter to filter at least one pixel value in said current line of pixels if said first filter decision value is below said first threshold, as determined by said first filter threshold comparator, and said second filter decision value is below said second threshold, as determined by said second threshold comparator, and to otherwise select a weak de-blocking filter to filter at least one pixel value in said current line of pixels, wherein said strong de-blocking filter has a comparatively higher filtering strength as compared to said weak de-blocking filter.

31. A decoder comprising a filtering control device, the filtering control device comprising:
a first decision value calculator configured to calculate a first filter decision value for a block of multiple pixels in a video frame, each pixel having a respective pixel value, said first filter decision value representative of how smooth pixel values in a first line of pixels in said block and in a corresponding first line of pixels in a neighboring block of multiple pixels in said video frame are in a direction parallel to a filtering direction;
a second decision value calculator configured to calculate a second filter decision value for said block representative of how close pixel values in a current line of pixels in said block approximate a flat line and how close pixel values in a corresponding current line of pixels in said neighboring block approximate a flat line;
a first threshold comparator configured to compare said first filter decision value calculated by said first decision value calculator to a first threshold;
a second threshold comparator configured to compare said second filter decision value calculated by said second decision value calculator to a second threshold; and
a filter selector configured to select a strong de-blocking filter to filter at least one pixel value in said current line of pixels if said first filter decision value is below said first threshold, as determined by said first filter threshold comparator, and said second filter decision value is below said second threshold, as determined by said second threshold comparator, and to otherwise select a weak de-blocking filter to filter at least one pixel value in said current line of pixels, wherein said strong de-blocking filter has a comparatively higher filtering strength as compared to said weak de-blocking filter.

32. A media terminal comprising:
a memory configured to store encoded video frames;
a decoder configured to decode said encoded video frames into decoded video frames, said decoder including a filtering control device, the filtering control device comprising:
a first decision value calculator configured to calculate a first filter decision value for a block of multiple pixels in a video frame, each pixel having a respective pixel value, said first filter decision value representative of how smooth pixel values in a first line of pixels in said block and in a corresponding first line of pixels in a neighboring block of multiple pixels in said video frame are in a direction parallel to a filtering direction;
a second decision value calculator configured to calculate a second filter decision value for said block representative of how close pixel values in a current line of pixels in said block approximate a flat line and how close pixel values in a corresponding current line of pixels in said neighboring block approximate a flat line;
a first threshold comparator configured to compare said first filter decision value calculated by said first decision value calculator to a first threshold;
a second threshold comparator configured to compare said second filter decision value calculated by said second decision value calculator to a second threshold; and
a filter selector configured to select a strong de-blocking filter to filter at least one pixel value in said current line of pixels if said first filter decision value is below said first threshold, as determined by said first filter threshold comparator, and said second filter decision value is below said second threshold, as determined by said second threshold comparator, and to otherwise select a weak de-blocking filter to filter at least one pixel value in said current line of pixels, wherein said strong de-blocking filter has a comparatively higher filtering strength as compared to said weak de-blocking filter.
a media player configured to render said decoded video frames into video data displayable on a display.
